(19) United States
(12) Patent Application Publication
(10) Pub. No.: US 2006/0015328 A1
(43) Pub. Date: Jan. 19, 2006

(54) Sinusoidal audio coding

(75) Inventors: Nicolle Hanneke Van Schijndel, Eindhoven (NL); Mireia Gomez Fuentes, Badalona (ES); Steven Leonardos Josephus Dimphina Elisabeth Van De Par, Eindhoven (NL); Andreas Johannes Gerrits, Eindhoven (NL); Valery Stepanovich Kot, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,241

(22) PCT Filed: Oct. 29, 2003
(86) PCT No.: PCT/IB03/04869

§ 371 Date: May 24, 2005

(30) Foreign Application Priority Data
Nov. 27, 2002 (EP) 02079939.1

(51) Int. Cl. G10L 19/08

(52) U.S. Cl. 704/219

(57) ABSTRACT

Coding of an audio signal (x) represented by a respective set of sampled signal values for each of a plurality of sequential segments is disclosed. The sampled signal values are used to determine sinusoidal components (CS) for each of the plurality of sequential segments. The sinusoidal components (CS) are subtracted from the sampled signal values to provide a set of values (s1, s2) representing afirst residual component (x3) of the audio signal. The first residual component (x3) is conditioned (18) to remove selected tonal components and to provide a set of values (s1′, s2′) representing a second residual component (x3′) of the audio signal. The second residual component is modelled (14) by determining noise parameters (CN) approximating the second residual component (x3′); and an encoded audio stream (AS) is generated including the noise parameters (CN) and the codes representing the sinusoidal components (CS).

### FIELD OF THE INVENTION

The present invention relates to coding audio signals.

### BACKGROUND OF THE INVENTION

Referring now to FIG. 1, a parametric coding scheme in particular a sinusoidal coder is described in PCT Patent Application No. WO01/69593. In this coder, an input audio signal x(t) is split into several (overlapping) segments, typically of length 20 ms. Each segment is decomposed into transient, sinusoidal and noise components. This decomposition is done sequentially, i.e. the transients are first extracted from the input signal x(t) in a transient coder 11 to leave a 1^{st} residual signal x1/x2 depending on whether gain control is applied or not; the 1^{st} residual signal is coded using a sinusoidal coder 13; then the coded sinusoids are extracted from the 1^{st} residual signal to leave a 2^{nd} residual signal x3; this 2^{nd} residual signal is in turn coded using a noise coder 14.

In the sinusoidal analyser 130, the 1^{st} residual signal x2 for each segment is modelled using a number of sinusoids represented by amplitude, frequency and phase parameters. Once the sinusoids for a segment are estimated, a tracking algorithm is initiated. This algorithm links sinusoids with each other on a segment-to-segment basis to obtain so-called tracks. The tracking algorithm thus results in sinusoidal codes C_{S} comprising sinusoidal tracks that start at a specific time instance, evolve for a certain amount of time over a plurality of time segments and then stop.

A number of coding methods can be employed in the noise coder to model the 2^{nd} residual signal x3. For trasparent audio quality, the noise coder can be a wave form coder in the form of a filter bank. Alternatively, for good quality and low bit-rate, the noise coder can employ a synthetic noise model to produce, for example, Autoregressive Moving Average (ARMA) or Linear Predictive Coding (LPC) filter parameters.

It is also possible to derive other components of the input audio signal such as harmonic complexes. The present specification relates only to sinusoidal and noise components, but the extension to harmonic complexes does not affect the invention in any way.

The extraction of sinusoids from a segment of an audio signal can be problematic. Within segments, sinusoidal amplitudes and frequencies can vary and this is referred to as instationarity. Furthermore, inaccuracies can occur in the estimation of the sinusoids. As a result, the spectral suppression achieved using the coded sinusoids is not always satisfactory or ideal. This results in the presence of sinusoidal-like components especially at or near the positions of the coded sinusoids in the 2^{nd} residual signal.

In addition, at low bit rates, where there are only enough bits to code a few sinusoids, sinusoidal components will still be present in the 2^{nd} residual.

Noise coders in general model the temporal and spectral envelope of the residual signal x3 rather coarsely, i.e. they have a limited spectral resolution and artefacts can appear when a noise coder models sinusoidal components. Even if tonal components remaining in the residual are masked, audible artefacts can occur, due to the limited spectral resolution of the noise model. This is especially likely to occur at low frequencies where the auditory system has a good spectral resolution and spectral resolution of the noise coder is usually worse. Also, in contrast to a stationary, tonal signal, the energy of the noisy component will always fluctuate over time. These fluctuations may make a previously masked tonal component audible. Energy fluctuations will be biggest in regions where spectral resolution should be good, i.e. at low frequencies. Thus, apart from the fact that in trying to model the sinusoidal-like components in the residual signal x3, the noise coder requires additional bits for the noise codes C_{N}, modelling these components as noise may result in audible artefacts, particularly at low frequencies.

The present invention attempts to mitigate this problem.

### DISCLOSURE OF THE INVENTION

According to the present invention there is provided a method according to claim 1.

The invention includes a re-analysis stage prior to the noise coder. In one embodiment, tonal components are removed from the residual by, for example, matching pursuit in combination with an energy-based stopping criterion which determines when to stop extracting tonal components.

In another embodiment, the residual signal is additionally suppressed at the frequencies of the coded sinusoids and their surroundings. The number of surrounding frequencies can be fixed or dependent on the frequency. A psycho-acoustical frequency division (e.g. Bark/Erb bands) can also be used. The amount of suppression can for example depend on the number of sinusoids, or the energy of the sinusoids. As a result, the noise coder does not need to model these sinusoidal regions any more.

### BRIEF DESCRIPTION OF THE DRAWINGS

FIG. 1 shows a prior art audio recorder including an audio encoder;

FIG. 2 shows an embodiment of an audio coder according to the invention;

FIG. 3 shows an embodiment of an audio player including an audio decoder operable with the coder of the invention;

FIG. 4 illustrates the processing performed by the re-analyser of the embodiments of the invention; and

FIG. 5 shows a system comprising an audio coder according to the invention and an audio player.

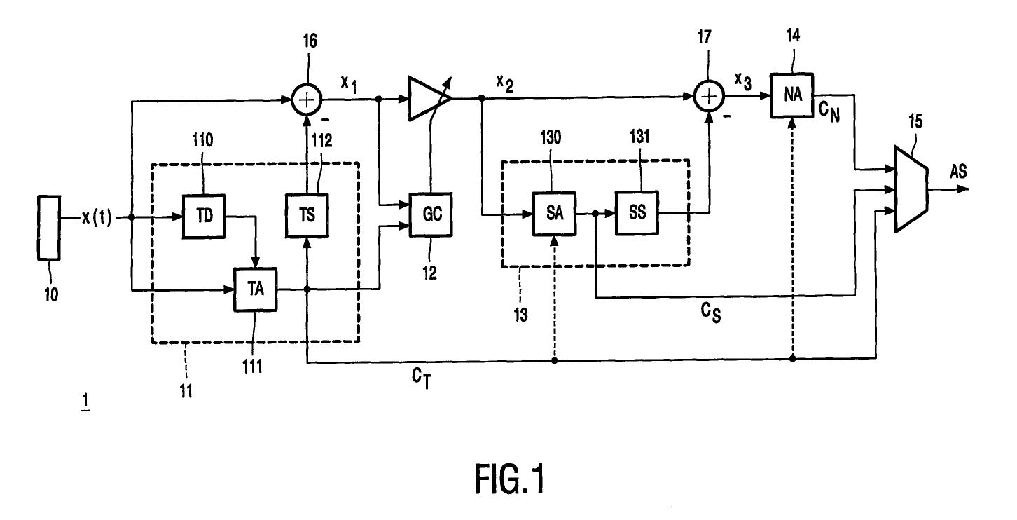

### DESCRIPTION OF THE PREFERRED EMBODIMENT

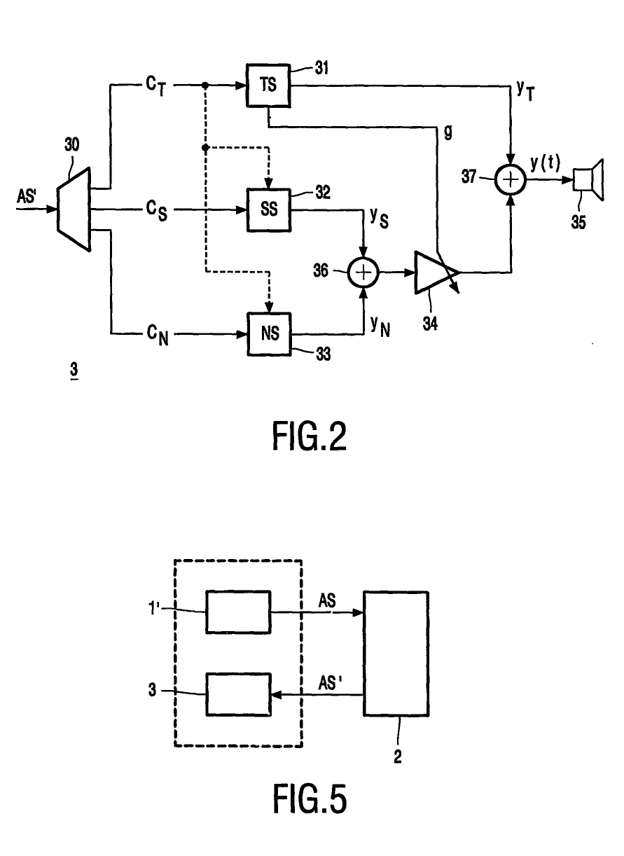

Preferred embodiments of the invention will now be described with reference to the accompanying drawings wherein like components have been accorded like reference numerals and, unless otherwise stated perform a like function. In a preferred embodiment of the present invention, FIG. 2, the encoder 1′ is a sinusoidal coder of the type described in PCT Patent Application No. WO 01/69593. The operation of this prior art coder and its corresponding decoder has been well described and description is only provided here where relevant to the present invention.

In both the prior art and the preferred embodiment, the audio coder 1′ samples an input audio signal at a certain sampling frequency resulting in a digital representation x(t) of the audio signal. The coder 1′ then separates the sampled input signal into three components: transient signal components, sustained deterministic components, and sustained stochastic components. The audio coder 1′ comprises a transient coder 11, a sinusoidal coder 13 and a noise coder 14.

The transient coder 11 comprises a transient detector (TD) 110, a transient analyzer (TA) 111 and a transient synthesizer (TS) 112. First, the signal x(t) enters the transient detector 110. This detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code CT and more detailed information on generating the transient code CT is provided in PCT Patent Application No. WO 01/69593.

The transient code CT is furnished to the transient synthesizer 112. The synthesized transient signal component is subtracted from the input signal x(t) in subtractor 16, resulting in a signal x2.

The signal x2 is furnished to the sinusoidal coder 13 where it is analyzed in a sinusoidal analyzer (SA) 130, which determines the (deterministic) sinusoidal components. It will therefore be seen that while the presence of the transient analyser is desirable, it is not necessary and the invention can be implemented without such an analyser. Alternatively, as mentioned above, the invention can be implemented with for example an harmonic complex analyser. In any case, the end result of sinusoidal coding is a sinusoidal code CS and a more detailed example illustrating the conventional generation of an exemplary sinusoidal code CS is provided in PCT Patent Application No. WO 00/79519.

In brief, however, such a sinusoidal coder encodes the input signal x2 as tracks of sinusoidal components linked from one frame segment to the next. From the sinusoidal code CS generated with the sinusoidal coder, the sinusoidal signal component is reconstructed by a sinusoidal synthesizer (SS) 131. This signal is subtracted in subtractor 17 from the input x2 to the sinusoidal coder 13, resulting in a remaining signal x3.

According to the present invention, there is provided a re-analyser 18, which conditions the residual signal x3 prior to encoding by a noise coder 14. In each of the embodiments of the invention, the re-analyser 18 selectively removes or suppresses spectral regions at or near the positions of tonal components from the residual signal x3 and provides a conditioned residual signal x3′ to the noise coder 14.

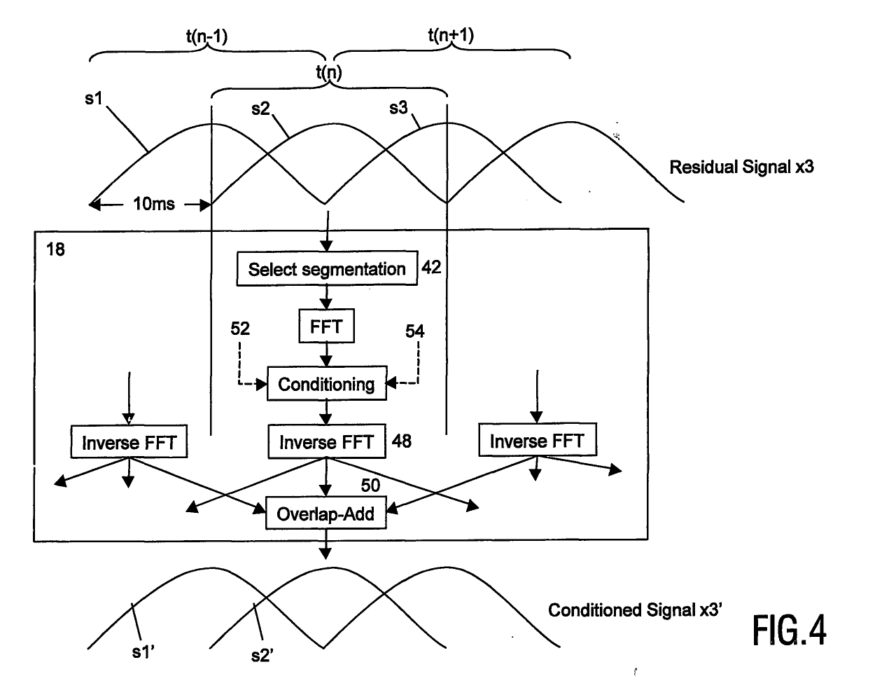

Referring now to FIG. 4, as mentioned above, in the embodiments, the residual signal x3 provided to the re-analyser 18 comprises segments s1,s2 . . . overlapping in successive time frames t(n−1), t(n), t (n+1). Typically sinusoids are updated at a rate of 10 ms and each segment s1,s2 . . . is twice the length of the update rate, i.e. 20 ms. In each of the embodiments, the re-analyser 18 provides the overlapping time windows t(n−1),t(n),t(n+1) to be re-analysed by using a Hanning window function to combine the signals from overlapping segments s1,s2 . . . into a single signal representing a time window, step 42. An FFT (Fast Fourier Transform) is applied on the windowed signal, resulting in a complex frequency spectrum representation of the time window signal, step 44. For a sampling rate of 44.1 kHz and a frame length of 20 ms, the length of the FFT is typically 2048.

In a first embodiment, in the re-analyser 18, conditioning of the spectrum generated by the FFT, step 46, comprises applying a conventional type matching pursuit algorithm to iteratively remove peaks from the spectrum. In the first embodiment, the algorithm iteratively removes those peaks that result in the greatest reduction of energy. In general this will mean that the matching pursuit algorithm first extracts peaks corresponding to tonal components and then tends to extract noisy peaks, because the reduction in energy is, on average, bigger for the extraction of tonal peaks than for the extraction of noisy ones. Thus, the extraction should stop just after the extraction of all tonal components and just before the extraction of noisy ones. On the one hand, if not all tonal components are removed, when synthesised in a decoder, the signal may be too noisy, because tonal components will have been modelled by the noise coder 14. On the other hand, if too many and thus some noisy components are removed, the synthesised signal may sound metallic, because of resulting gaps in unsuitable regions of the spectrum of the residual signal x3′ provided to the noise coder 14.

In one implementation of the first embodiment, a stopping criterion indicates when to stop extracting components. This criterion is based on the energy of the residual before and after the extraction of a peak. Thus, when the reduction in energy after removal of a peak is less than a certain percentage, this indicates that all tonal peaks have been extracted and that the conditioned residual x3′ will be free of tonal components.

Since the reduction in energy depends on the length of the analysis window, the energy criterion is inversely proportional to the window length. For example, for a window length of 1024 sample points at 48 kHz (=21 ms), a useful value for the criterion is at a reduction in energy of 5%, whereas for a window length of 512 sample points at 48 kHz (=10.5 ms), it is 10%.

In another implementation of the first embodiment, a fixed number of peaks are extracted, i.e. matching pursuit runs through a fixed number of iterations.

As an alternative to the iterative matching pursuit approach of the first embodiment, in a second embodiment, the conditioning step 46 picks and removes a number (fixed or variable (for example all peaks in the spectrum)) of the highest energy peaks from the spectrum generated in step 44 in a single step. This technique has the advantage that it is faster (being performed in a single iteration) than matching pursuit, however, it may lose the benefit of picking up peaks masked by more powerful peaks that may be detected by matching pursuit.

In the cases above where a fixed number of peaks are removed either iteratively or in a single step, it has been found experimentally that the extraction of 5 peaks or less resulted in better, less noisy signals while the extraction of more than 5 peaks resulted in a less noisy but metallic sounding signal.

In all of the above implementations, the re-analyser 18 takes an inverse FFT of the residual spectrum when matching pursuit has completed to obtain a time domain signal, step 48. By applying overlap-add for successive conditioned time domain signals, step 50, the conditioned residual x3′ is created and this is fed through the noise module 14. It will be seen that the conditioned segments s1′, s2′. . . of the residual x3′ correspond to the segments s1, s2 . . . in the time domain and as such no loss of synchronisation occurs as a result of the re-analysis.

It will be seen that where the residual signal x3 is not an overlapping signal but rather is a continuous time signal, then the windowing step 42 will not be required. Similarly, if the noise coder 14 expects a continuous time signal rather than an overlapping signal, the overlap-add step 50 will not be required. Nonetheless, it will also been seen that the first embodiment can be implemented without requiring any changes to be made to the conventional sinusoidal coder 13 or the noise coder 14. Also, in both of the above implementations psycho-acoustic considerations do not have to be taken into account when conditioning the signal x3 to produce the signal x3′.

In third and fourth embodiments of invention, while no changes need to be made to the internal operation of the sinusoidal coder 13, the re-analyser 18 is provided with the sinusoidal codes Cs for each segment s1, s2 . . . as indicated by the dashed line 52 of FIGS. 2 and 4. Again, sinusoidal codes for successive segments need to be combined to provide a single set of values for each time window t(n−1), t(n), t(n+1). In the third embodiment, for each of the sinusoids that are estimated for a given time window, as indicated by the frequency parameter for each sinusoidal component, the conditioning step 46 determines the corresponding frequency bin in the spectrum derived at step 44. The frequency bin is then multiplied by a factor (e.g. 0.001), i.e. severely attenuated. Also adjacent frequency bins are suppressed (e.g. by a factor of 0.01) and this results in a conditioned complex spectrum. As before, an inverse FFT is applied to this conditioned spectrum, step 48 and processing continues as before.

In the fourth embodiment of the invention, the re-analyser 18 is provided with the original signal for each segment s1, s2 . . . as indicated by the dashed line 56 of FIGS. 2 and 4. In the conditioning step 46, the frequency bins of the complex spectrum derived at step 44 are combined in non-equidistant frequency bands according to a psycho-acoustical model (e.g. Bark, Erb). Per psycho-acoustic based frequency band, the energy of the sinusoids derived from the sinusoidal codes Cs in that band (line 52) and the energy of the original input signal in that band (line 56) are compared. Instead of the actual energies of sinusoids and original in a band, also estimates may be used. A possible estimate of the original energy is the energy of the sinusoidal components plus the energy of the residual. This estimate is only equal to the actual energy of the residual if the sinusoidal components and the residual are uncorrelated. A possible estimate of the sinusoidal energy is the energy of the original minus the energy of the residual. Again, this estimate is only equal to the actual energy of the sinusoidal components if the original and the residual are uncorrelated in that band. If the difference is small (e.g. 2 dB), the frequency bins in the frequency band for the spectrum derived at step 44 are set to zero based on the assumption that in this particular frequency region the original signal is described well enough by the sinusoids. A band is also put to zero if the energy of the sinusoidal components is higher than the energy of the original. This may, for example happen when different windows are used. As before an inverse FFT can be applied to this conditioned spectrum, step 48 and processing can continue as before with the conditioned time domain signal x3′ being fed to noise coder 14.

However, by setting frequency bands to zero, noise parameters can be encoded very efficiently resulting in a considerable coding gain. Thus, if the conditioned frequency spectra generated at step 46 were fed directly to an adapted noise coder, the noise coder may be able to apply for example, run-length coding to take advantage of the gain of a number of consecutive frequency bands being zero. In existing state-of-the-art noise coders run-length coding is not applied, because without conditioning it only rarely occurs that parts of the residual spectrum are zero. However, by applying spectral blanking, run-length encoding will result in a considerable bit-rate reduction. Corresponding changes would of course need to be made to the decoder to take account of any changes in the coding of noise information.

In a fifth embodiment of the invention, rather than providing the sinusoidal codes Cs to the analyser 18, the sinusoidal coder 13 is adapted to provide to the re-analyser 18 the parameters for sinusoidal components which were detected by the sinusoidal analyser 130 but dropped during the coding process as indicated by the line 54 in FIGS. 2 and 4. As well as frequency and amplitude values, these parameters also include an indication of the reason for dropping the sinusoids. Although not an exclusive list of types, these can include:
The sinusoid was too short to be useful for tracking (S);
The sinusoid was masked by a more powerful sinusoid (M);
The sinusoid was dropped to reduce the bit rate. (B).

In the case of types M and B, it will be seen that these components are more likely to be tonal than in the case of type S. Therefore in the fifth embodiment, the conditioning step 46 comprises removing a number (fixed or variable) of the highest energy peaks corresponding to M and B type frequencies before providing the conditioned spectrum for processing as before in steps 48, 50.

While each of the above embodiments has been described independently, it will be seen that one or more of these techniques may be combined in the conditioning step 46. For example, the steps of the fifth embodiment may be performed to remove a limited number of M or B type components before the steps of the first embodiment are performed to remove other peaks.

It will also be seen that while each of the embodiments have been described in terms of conditioning the residual signal x3 in the frequency domain, the re-analyser 18 could equally operate in the time domain.

In any case, the conditioned signal x3′ produced by the re-analyser 18 can now more properly be assumed to comprise only noise and the noise analyzer 14 of the preferred embodiment produces a noise code CN representative of this noise, as described in, for example, PCT patent application No. PCT/EP00/04599.

Finally, in a multiplexer 15, an audio stream AS is constituted which includes the codes CT, CS and CN. The audio stream AS is furnished to e.g. a data bus, an antenna system, a storage medium etc.

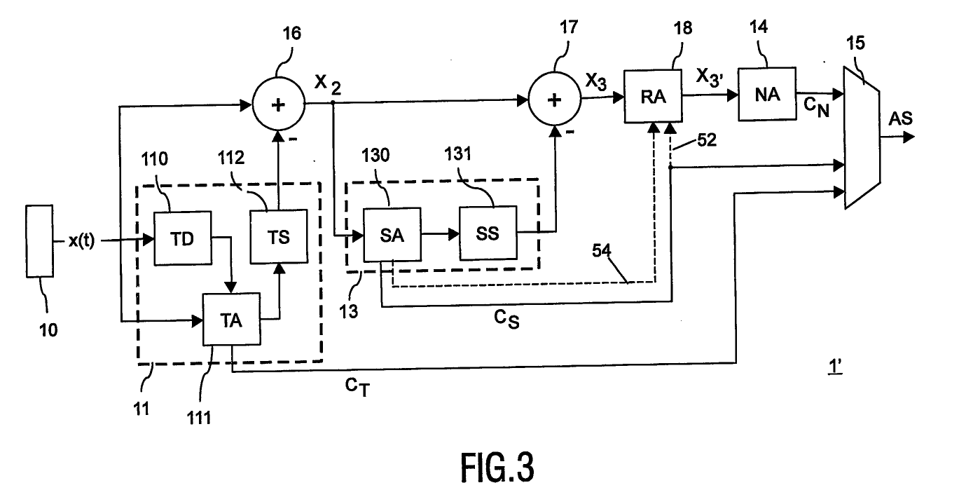

FIG. 3 shows an audio player 3 suitable for decoding an audio stream AS′, e.g. generated by an encoder 1′ of FIG. 2, obtained from a data bus, antenna system, storage medium etc. Unless stated, the audio player 3 is as described in PCT Patent Application No. WO01/69593. In brief, in such an player, the audio stream AS′ is de-multiplexed in a de-multiplexer 30 to obtain the codes CT, CS and CN. These codes are furnished to a transient synthesizer 31, a sinusoidal synthesizer 32 and a noise synthesizer 33 respectively. From the transient code CT, the transient signal components are calculated in the transient synthesizer 31. In case the transient code indicates a shape function, the shape is calculated based on the received parameters. Further, the shape content is calculated based on the frequencies and amplitudes of the sinusoidal components. If the transient code CT indicates a step, then no transient is calculated. The total transient signal yT is a sum of all transients.

The sinusoidal code CS is used to generate signal yS, described as a sum of sinusoids on a given segment. At the same time, as the sinusoidal components of the signal are being synthesized, the noise code CN is fed to a noise synthesizer NS 33, which is mainly a filter, having a frequency response approximating the spectrum of the noise. The NS 33 generates reconstructed noise yN by filtering a white noise signal with the noise code CN.

In the player of FIG. 3, additional suppression of frequency regions near or at positions of sinusoids described by CS is applied by a re-analyser 39 corresponding to the first to fourth embodiments of the re-analyser 18 described above. The re-analyser therefore removes unwanted components that can be present in the noise signal yN to produce a conditioned noise signal yN′. These unwanted components are for example parts of tonal components that are modeled as noise in the encoder (1 or 1′). By using this method in the decoder, the noisiness can be reduced and a better sound quality is obtained. Furthermore, the decoder is less dependent on the performance of the noise encoding and it is less of a problem if for some reason not all tonal components are removed from the residual signal x3/x3′ in the noise encoder.

The total signal y(t) comprises the sum of the transient signal yT and the product of any amplitude decompression (g) and the sum of the sinusoidal signal yS and the noise signal yN′. The audio player comprises two adders 36 and 37 to sum respective signals. The total signal is furnished to an output unit 35, which is e.g. a speaker.

FIG. 5 shows an audio system according to the invention comprising an audio coder 1′ as shown in FIG. 2 and an audio player 3 as shown in FIG. 3. Such a system offers playing and recording features. The audio stream AS is furnished from the audio coder to the audio player over a communication channel 2, which may be a wireless connection, a data 20 bus or a storage medium. In case the communication channel 2 is a storage medium, the storage medium may be fixed in the system or may also be a removable disc, memory stick etc. The communication channel 2 may be part of the audio system, but will however often be outside the audio system.

1. A method of encoding an audio signal, the method comprising the steps of:
providing a respective set of sampled signal values for each of a plurality of sequential segments;
analysing the sampled signal values to determine zero or more sinusoidal components for each of the plurality of sequential segments;
subtracting said sinusoidal components from said sampled signal values to provide a set of values representing a first residual component of said audio signal;
conditioning said first residual component of said audio signal to remove selected tonal components from said first residual component and to provide a set of values representing a second residual component of said audio signal;
modelling the second residual component of the audio signal by determining noise parameters approximating the 2^{nd} residual component; and
generating an encoded audio stream including said noise parameters and codes representing said sinusoidal components.

2. A method according to claim 1 wherein said conditioning step comprising:
providing a frequency spectrum representation for sequential segments of said set of values representing said first residual component of said audio signal;
attenuating selected frequencies within each frequency spectrum representation; and
providing a time domain representation for said sequential segments of frequency spectrum representations in which said selected frequencies have been attenuated.

3. A method according to claim 2 in which said attenuating step comprises:
iteratively removing peaks of the greatest energy from said frequency spectrum representations.

4. A method according to claim 3 in which said iterations are stopped when the energy of the removed peak is less than a given percentage of the overall energy of the frequency spectrum representation from which the peak is removed.

5. A method according to claim 4 in which said energy level is inversely proportional to the length of said sequential segments.

6. A method according to claim 3 in which said iterations are stopped after a fixed number of iterations.

7. A method according to claim 2 in which said attenuating step comprises:
removing a fixed number of peaks of the greatest energy from said frequency spectrum representations.

8. A method according to claim 2 in which said attenuating step comprises:
determining frequency values for each of the sinusoidal components representing a sequential segment corresponding to the sequential segment for the frequency spectrum representation; and
attenuating the frequency values of said frequency spectrum representation in the region of said frequency values for each of the sinusoidal components.

9. A method according to claim 2 in which said attenuating step comprises:
determining first energy values for each of the sinusoidal components representing a sequential segment corresponding to the sequential segment for the frequency spectrum representation;
determining second energy values for sampled signal values in said sequential segment corresponding to the sequential segment for the frequency spectrum representation; and
dividing said frequency spectrum representations into frequency bands according to a psycho-acoustic model;
zeroing the values for frequency bands where said first and second energy values are similar.

10. A method according to claim 9 wherein said encoded audio stream is generated with run-length coding representing sequences of frequency bands where values have been zeroed.

11. A method according to claim 2 wherein said analysing step comprises generating sinusoidal codes comprising tracks of linked sinusoidal components; and synthesizing said sinusoidal components using said sinusoidal codes and wherein said subtracting step comprises subtracting said synthesized signal values from said sampled signal values to provide said set of values representing the first residual component of said audio signal.

12. A method according to claim 11 wherein said attenuating step comprises:
determining frequency values for sinusoidal components of said audio signal which were not used in generating said sinusoidal codes;
determining if said sinusoidal components were not used for reasons including: said components being too short, said components being masked by other components and budgetary reasons; and
attenuating the frequency values of said frequency spectrum representation in the region of unused sinusoidal components where said components were not used for being masked or for budgetary reasons.

13. A method according to claim 1 wherein said sampled signal values represent an audio signal from which transient components have been removed.

14. Method of decoding an audio stream, the method comprising the steps of:
reading an encoded audio stream including codes representing a noise component of an audio signal;
employing said codes to synthesize said noise component of said audio signal to produce a synthesized signal; and
conditioning said synthesized signal to remove selected tonal components from said signal.

15. Audio coder arranged to process a respective set of sampled signal values for each of a plurality of sequential segments of an audio signal, said coder comprising:
an analyser for analysing the sampled signal values to determine zero or more sinusoidal components for each of the plurality of sequential segments;
a subtractor for subtracting said sinusoidal components from said sampled signal values to provide a set of values representing a first residual component of said audio signal;
a conditioner for removing selected tonal components from said first residual component and providing a set of values representing a second residual component of said audio signal;
a noise coder for modelling the second residual component of the audio signal by determining noise parameters approximating the 2^{nd} residual component; and
a bitstream generator for generating an encoded audio stream including said noise parameters and codes representing said sinusoidal components.

16. Audio player comprising:
mean for reading an encoded audio stream including codes representing a noise component of an audio signal;
a synthesizer arranged to employ said codes to synthesize said noise component of said audio signal to produce a synthesized signal; and
a conditioner arranged to remove selected tonal components from said synthesized signal.

17. Audio system comprising an audio coder arranged to process a respective set of sampled signal values for each of a plurality of sequential segments of an audio signal, and an audio player, said audio coder comprising:
an analyser for analysing the sampled signal values to determine zero or more sinusoidal components for each of the plurality of sequential segments;
a subtractor for subtracting said sinusoidal components from said sampled signal values to provide a set of values representing a first residual component of said audio signal;
a conditioner for removing selected tonal components from said first residual component and providing a set of values representing a second residual component of said audio signal;
a noise coder for modelling the second residual component of the audio signal by determining noise parameters approximating the 2^{nd} residual component; and
a bitstream generator for generating an encoded audio stream including said noise parameters and codes representing said sinusoidal components, and said audio player comprising:
mean for reading an encoded audio stream including codes representing a noise component of an audio signal;
a synthesizer arranged to employ said codes to synthesize said noise component of said audio signal to produce a synthesized signal; and
a conditioner arranged to remove selected tonal components from said synthesized signal.
